(19) United States
(12) Patent Application Publication
(10) Pub. No.: US 2012/0012550 A1
(43) Pub. Date: Jan. 19, 2012

(54) Nipple for a Baby Container with Pressure-Equalizing Valve

(75) Inventor: Pruck Boonprasop, Samut Sakorn (TH)

(73) Assignee: ROYAL INDUSTRIES (THAILAND) PUBLIC COMPANY LIMITED, Omnoi (TH)

(21) Appl. No.: 12/835,590

(22) Filed: Jul. 13, 2010

(51) Int. Cl. A61J 9/00; B23P 17/04; A61J 9/04

(52) U.S. Cl. 215/11.4; 215/11.5; 29/428

(57) ABSTRACT

A nipple comprising a teat, a mounting flange coupled to the teat defining a valve cavity therein, and a valve positioned with in the valve cavity, in which the valve is configured to equalize differing pressures. A system and method comprising a container and a nipple configured to be selectively and sealingly coupled to the container, in which the nipple further comprises a valve and valve cavity configured to equalize the pressure differences between the ambient environment and interior of the container, in which the valve cavity has a minimum volumetric capacity of 0.9 cubic centimeters, and in which the valve cavity has a stepped triangular cross-section positioned at the bottom of the valve having a minimum wall thickness of 0.8 millimeters and a minimum height of 3.0 millimeters.

### BACKGROUND

The benefits of breastfeeding an infant compared to artificial means of feeding have been well documented. Some studies have shown that breastfeeding can prevent certain illness in newborns such as diabetes, extreme obesity, food and environment allergies, necrotizing enterocolitis in premature infants, as well as increased risks of cardiovascular diseases among others. More importantly, breastfeeding a newborn infant can create a particular bond between the infant and mother. Additionally, it has been further documented that nursing provides health benefits to the nursing mother such as increased weight loss as well as the release of certain hormones in the mother which help her recuperate faster from her injuries sustained during the birthing process.

Sadly, however, some mothers do not engage in breastfeeding for a number of reasons. One reason may be that the mother is apprehensive about breastfeeding or that she may feel it is not socially fashionable to do so. Another reason a mother may not breastfeed may be because she simply cannot because she may have contracted a disease such as HIV or tuberculosis which would pass onto the child if she was to nurse. Other reasons as to why a mother may not nurse her child exist. Suffice it to say, however, for these reasons new mothers who do not breastfeed their children are left to look for other means to provide food to the newborn.

One widespread method mothers use to provide food to their newborns is to allow the newborn to drink from a baby bottle or other container. A conventional baby bottle usually consists of a bottle or other container with an artificial nipple or teat attached at the top. The nipple is usually designed to be slimmer and more flexible than its natural counterpart; however, various designs are available. To say the least, there are a myriad of alternatives when choosing what nipple to purchase for a baby such as the type of material used, the flexibility of that material, the size of the nipple itself, as well as the volume of milk the nipple can hold among others.

However, problems have been found to arise with some conventional nipples available. Specifically, a conventional baby bottle may cause extreme pressure differences between that of the ambient pressure and the pressure on the inside of the bottle. With a conventional baby bottle, the infant sucks on the nipple and creates a vacuum inside of the container. This usually requires the mother or caregiver to take the bottle away from the infant mid-feeding in order to equalize the pressure differences. This may irritate the child to the point of crying and as such may add to the mounting stress felt by the mother or caregiver. Additionally, if left unchecked, the sucking of the nipple may actually cause the nipple itself to be sucked into the container creating an inverted nipple which would also irritate the child and interrupt his or her feeding.

In order to counteract this problem, some baby bottles come equipped with some form of venting mechanism which allows pressure to be equalized between the bottle and ambient air. Often these venting mechanisms allow ambient air to enter into the bottle only when the pressure is high enough to overcome the venting mechanism which may be a spring or even a specific material with a specific material resiliency. The amount of pressure required to overcome these venting mechanisms may unduly tax the infant's ability to suck from the nipple appropriately thereby causing more discomfort to the child. Therefore, a bottle that allows liquid to freely flow soon after the bottle orients to the feeding position and thereby requiring no suction force to pull the liquid out of the bottle.

Additionally, as hinted above, there are various shapes and sizes of nipples available on the market, however, most of these are not manufactured to imitate their natural counterpart. Specifically, very few nipples have attained a high level of natural feel to them which would sufficiently wean a child from breastfeeding. A common practice among mothers is to breastfeed for a certain period of time and then eventually wean the child off by introducing them to a baby bottle. However, this may prove to be difficult because the child may have become used to the feel of feeding off of a real breast and a rubber nipple may be so foreign to them that they may simply reject it. To alleviate this problem, a more naturally feeling baby bottle nipple is required.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a perspective view of a vented container nipple according to an embodiment of the present exemplary system.

FIG. 2 is a top view of a vented container nipple according to an embodiment of the present exemplary system.

FIG. 3A is a cross-sectional view of the nipple of FIG. 2 along the line A-A according to an embodiment of the present exemplary system.

FIG. 3B is a cross-sectional view of the nipple of FIG. 2 along the line F-F according to an embodiment of the present exemplary system.

FIG. 4 is a cross-sectional view of the vent of the container nipple of FIG. 3 within circle C with a closed valve according to an embodiment of the present exemplary system.

FIG. 5 is a cross-sectional view of the vent of the container nipple of FIG. 3 within circle C with an open valve according to an embodiment of the present exemplary system.

FIG. 6 is a top view of the valve cavity of the container of FIG. 2 within circle E according to an embodiment of the present exemplary system.

FIG. 7 is a cross-sectional view of the nipple of FIG. 2 along line B-B according to an embodiment of the present exemplary system.

FIG. 8 is a cross section view of the nipple of FIG. 3A within circle D and along line A-A of FIG. 2 according to an embodiment of the present exemplary system.

FIG. 9 is a cross section view of the nipple of FIG. 3B within circle E and along line F-F of FIG. 2 according to an embodiment of the present exemplary system.

FIG. 10 is a cross-sectional view of a container with the nipple of FIG. 3 according to an embodiment of the present exemplary system.

Throughout the drawings, identical reference numbers designate similar, but not necessarily identical, elements.

### DETAILED DESCRIPTION

Various systems and methods for making and using a container nipple are disclosed herein. The nipple is used to provide a means for equalizing pressures between the ambient atmosphere and the inside of the container. Through a valve, ambient air is allowed to flow easily into the container when the container is in an inverted position. Further, valve prevents the contents of the container from exiting from the valve.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As used in the present specification and the appended claims, the term “liquid” is meant to be understood broadly as any matter which exhibits a characteristic readiness to flow. Specific examples may be, but are not necessarily limited to, water, juice, various food purées, or even pharmaceuticals.

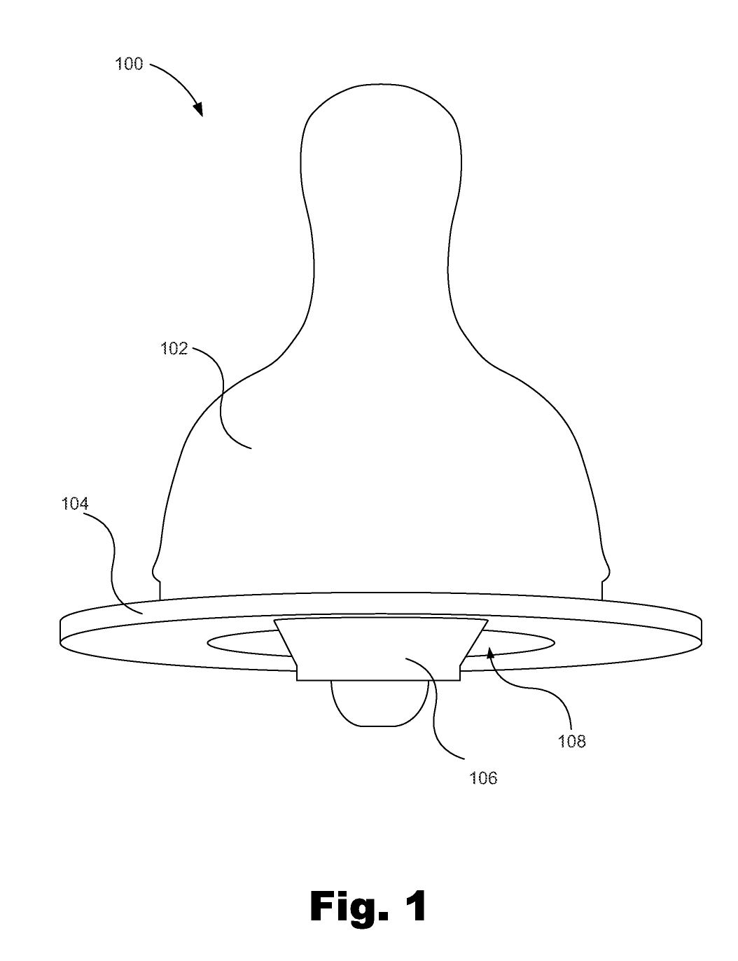

Turning now to FIG. 1, a perspective view of a vented container nipple (100) according to an embodiment of the present exemplary system is shown. The nipple (100) is made of a resilient material such as silicon, latex, rubber, or similar materials. This is done so that a child biting down on the nipple (100) will not injure their teeth or destroy the nipple itself. The nipple comprises a teat (102) upon which an infant can suck on in order to cause fluids to flow out of the nipple (100). The nipple (100) additionally comprises a mounting flange (104) configured to selectively seal in the contents in a container (FIG. 9, 118). This is done by a cap (FIG. 9, 120). Therefore, when the cap (FIG. 9, 118) is coupled to the container (FIG. 9, 118) the mounting flange is interposed between the cap (FIG. 9, 120) and container (FIG. 9, 118) so that a seal is created.

Furthermore, the nipple comprises a valve (106) configured to protrude into the container (FIG. 9, 118) and selectively allow airflow into the container (FIG. 9, 118). The valve (106) also includes a valve opening (not shown here) configured to allow ambient air to flow into the container (FIG. 9, 118) at a preconfigured rate. This is important, as will be appreciated later, because the amount of air allowed to flow into the container directly affects the ease at which a child will be able to draw the liquid from the container (FIG. 9, 118). Specifically in one embodiment, the valve opening (not shown here) may be a semicircular slit through the bottom surface of the valve (106).

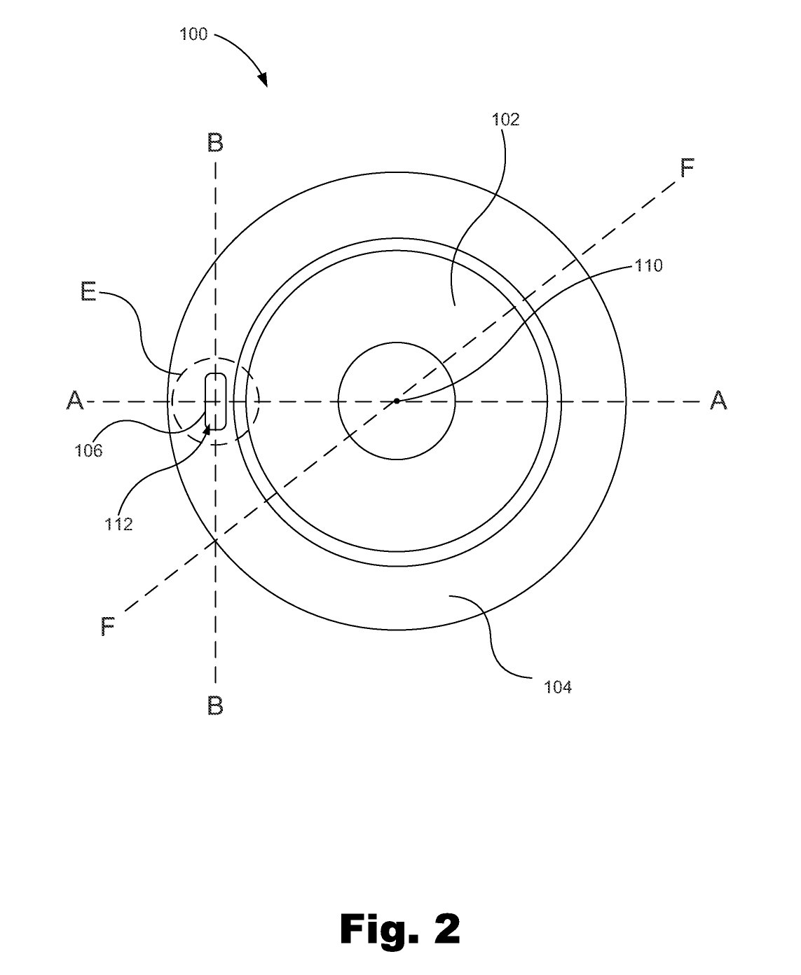

The nipple (100) additionally comprises an inner cavity (108) defined therein which holds a quantity of liquid in the container (FIG. 9, 118) when turned upside down. Additionally, the inner cavity (108) helps to direct the fluid in the container (FIG. 9, 118) to the tip of the teat (102) and eventually into the mouth of an infant. Each of these elements will be discussed in more detail below in connection with FIGS. 2-7.

FIG. 2 is a top view of a vented container nipple (100) according to an embodiment of the present exemplary system. In one embodiment, the valve (106) defines a valve cavity (112) within the nipple (100) along the mounting flange (102). In another embodiment, the valve (106) may define a valve cavity (112) which is located on the teat (102). In yet a further embodiment, there may be a number of valves (106) defining a number of valve cavities (112) along the mounting flange (104) each used to equalize the pressure in the container (FIG. 9, 118). In one exemplary embodiment, two valves (106) are situated on opposing sides of and along the mounting flange (104). This allows the interior pressure of the container (FIG. 9, 118) to be equalized easier. In yet another exemplary embodiment, four valves (106) are situated along the four directional sides of and along the mounting flange (104). This again allows the interior pressure of the container (FIG. 9, 118) to be equalized even easier. As can be appreciated, any number of valves (106) can be placed along the mounting flange (104) in order to better equalize the differing pressures of the interior of the container (FIG. 9, 118) and the ambient atmosphere.

The nipple (100) further comprises a nipple duct (110) defined in the teat (102) and configured to allow the liquid contained in the container (FIG. 9, 118) to be sucked out of the nipple (100). Sucking out the liquid is achieved by creating a negative pressure on the outside of the nipple (100) thereby causing the liquid to move outside of the nipple (100) in order to equalize that pressure. The nipple duct (110) may vary in diameter size, but preferably, the duct (110) is not too large. A large nipple duct (110) would allow the liquid inside the container (FIG. 9, 118) to flow out of the container (FIG. 9, 118) relatively too fast and thereby create spills. Conversely, a nipple duct (110) with a diameter that is relatively too small would cause the infant to strain too much in order to draw the liquid from the container (FIG. 9, 118). Therefore, the nipple duct (110) should be large enough to not strain the infant too much, but at the same time not allow liquid to flow out of it if the container (FIG. 9, 118) was to be inverted.

Additionally, the diameter of the nipple duct (110) in the present exemplary system will be dependant on the amount of air which the valve (not shown here) allows to enter into the container (FIG. 9, 118). This is because any ambient pressure will need to be equalized easily with the pressure inside the container (FIG. 9, 118). Again, if the nipple duct (110) is relatively too large or too small, the pressure will be too easily equalized or not equalized at all respectively.

Finally, is should be appreciated that the teat (102) can have a number of nipple ducts (110) defined therein. In one exemplary embodiment, any number of ducts (110) can be defined in the teat (102) each configured to equalize a portion of ambient pressure with the pressure inside the container (FIG. 9, 118) as described above. Also as described above, this is another feature that makes the nipple (100) feel more like a real nipple to a nursing child.

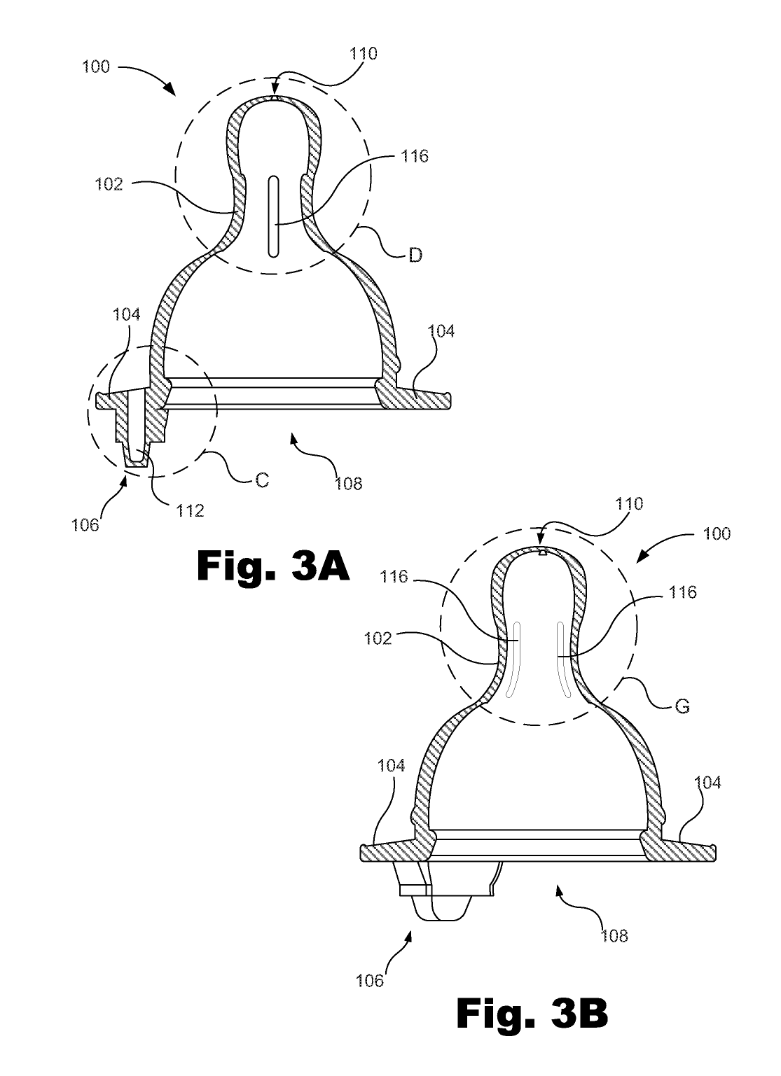

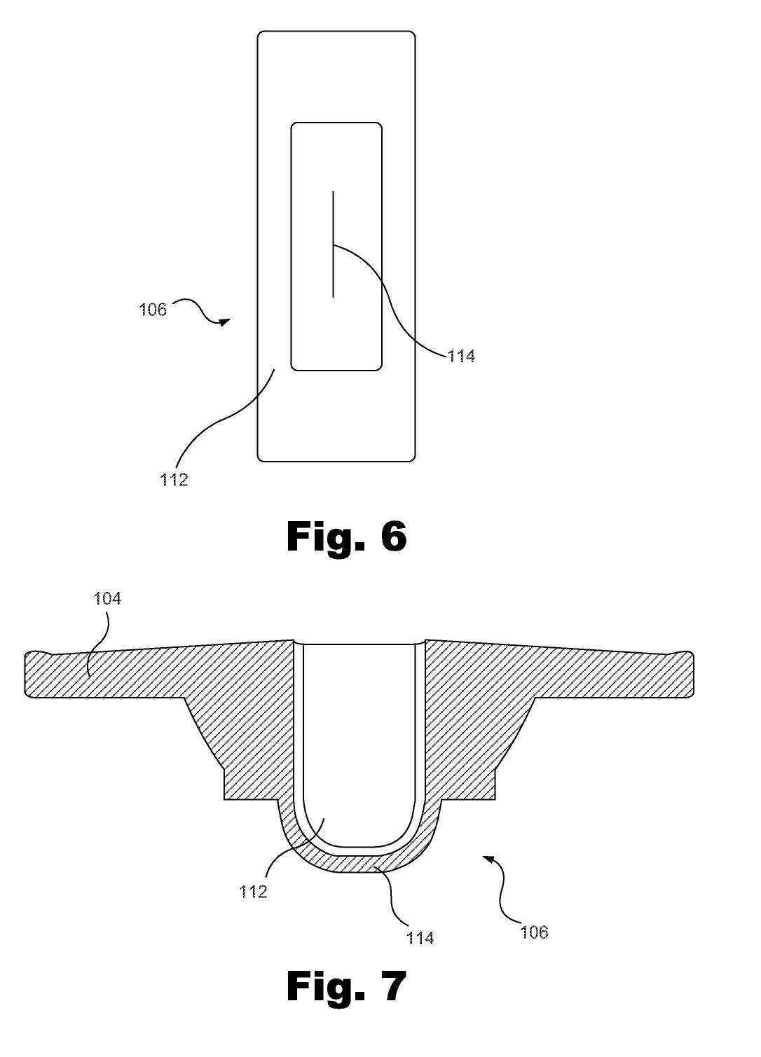

FIG. 2 further has line A-A defined thereon. Line A-A defines a plane cutting through the nipple (100). This is further shown in more detail in connection with FIG. 3A which shows a cross-sectional view of the nipple (100) according to one embodiment of the present exemplary system. FIG. 2 also has line B-B defined thereon. Line B-B also defines a plane cutting through the nipple (100). This plane is further shown in more detail in connection with FIG. 6 which shows the cross-sectional view of the nipple (100) and more particularly the valve (106) and valve cavity (112) of FIG. 2 according to an embodiment of the present exemplary system. FIG. 2 further has line F-F defined thereon. Line F-F defines a plane cutting through the nipple (100). This is further shown in more detail in connection with FIG. 3B which shows a cross-sectional view of the nipple (100) according to one embodiment of the present exemplary system. Finally, FIG. 2 has a circle E defined thereon. Circle E defines a top view of the valve cavity (112) and is shown in more detail in connection with FIG. 5 according to an embodiment of the present exemplary system. These individual views and their features will be discussed in more detail below.

It will be appreciated that the total size of the nipple (100) in FIG. 2 as well as the other figures may be varied according to how the nipple (100) is to be used and by whom. Specifically, the nipple (100) may be constructed with relatively smaller dimensions when the end user is a premature infant in comparison to a larger nipple (100) which may be intended to be used by a larger infant. This is necessary in order to accommodate for the individual child's physical differences such as the size of his or her mouth. Additionally, the resiliency of the material used to form the nipple (100) may need to be adjusted for similar reasons. Still further, the nipple (100) as well as the nipple duct (110) may vary in size depending on what is being fed to the infant. In one exemplary embodiment, the liquid in the container (FIG. 9, 118) may be thick and thereby may require a larger diameter of nipple duct (110) defined within the nipple (100) tip and thereby may also require the nipple (100) to be larger as well.

Moving on to FIG. 3A, a cross-sectional view of the nipple of FIG. 2 along the line A-A according to an embodiment of the present exemplary system is shown. As discussed earlier the nipple (100) is made of a resilient material such as silicon, latex or rubber. Additionally, the wall of the tip of the nipple (100) is configured to have a wall thickness greater than that of the middle portion of the nipple (100). Specifically, the nipple (100) tip and middle portion of the nipple (100) is configured to allow an infant to better grip the nipple in his or her mouth. Particularly the nipple (100), and more specifically the teat (102), has a profile and hardness which simulates a mother's breast. The features of the teat (102) will be discussed in more detail below in connection with FIG. 6.

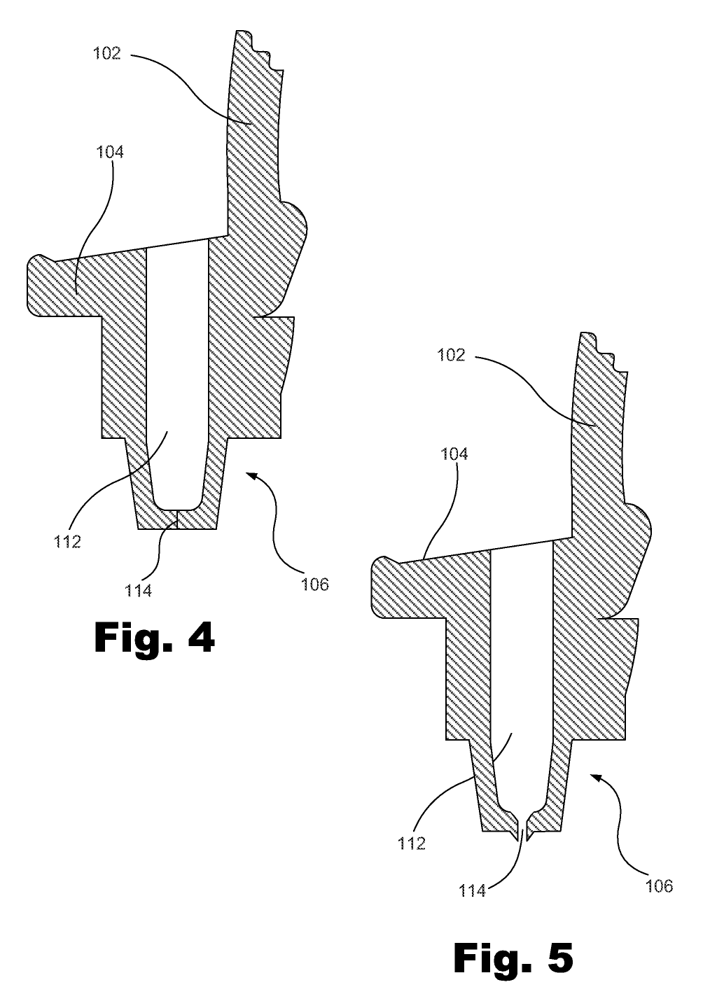

FIG. 3A also shows the valve (106) and valve cavity (112) defined within the mounting flange (104) according to an embodiment of the present invention. As discussed earlier, the placement of the valve (106) along the mounting flange (104) is merely one embodiment and it can be appreciated that the valve may be defined anywhere on the nipple (100). Additionally, in another embodiment, multiple valves (106) may be defined on the nipple (100). Preferably, each valve (106) and valve cavity (112) is defined along the mounting flange (104). This thereby prevents any discomfort or annoyance to a sucking child. The features of the valve (106) and valve cavity (112) will be discussed in more detail below in connection with FIGS. 4, 5, 6 and 7.

In one exemplary embodiment, the middle and tip portions of the teat (102) may include a number ribs (116) extending along and inside the nipple's (100) inner cavity (108). These ribs (116), may function as a means of support for the tip and middle of the teat (102). In one exemplary embodiment, the ribs (116) may run relatively vertical when the nipple (100) is viewed from the side as seen in FIGS. 3A and 3B. In another exemplary embodiment, the ribs (116) may run at an angle which is non-vertical and may spiral up towards the tip of the teat (102). In yet another exemplary embodiment, these ribs (116) may further be configured to imitate the internal ducts of a real female human breast.

It should be noted, however, that the wall thickness of the tip of the teat (102) is relatively thicker than the wall thickness of the middle section of the teat (102). Similarly, the wall thickness of the lower portion of the nipple (100) is relatively thicker than the wall thickness of the middle section of the teat (102). Again, the purpose of the varying wall thickness of the tip, middle and lower sections of the nipple (100) is to imitate, as best as possible, a real female human breast.

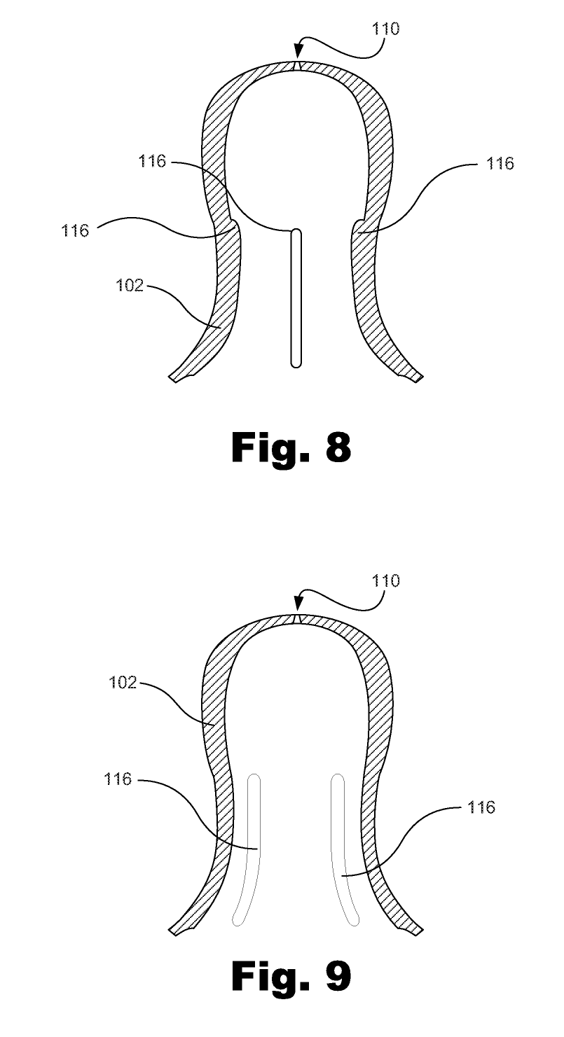

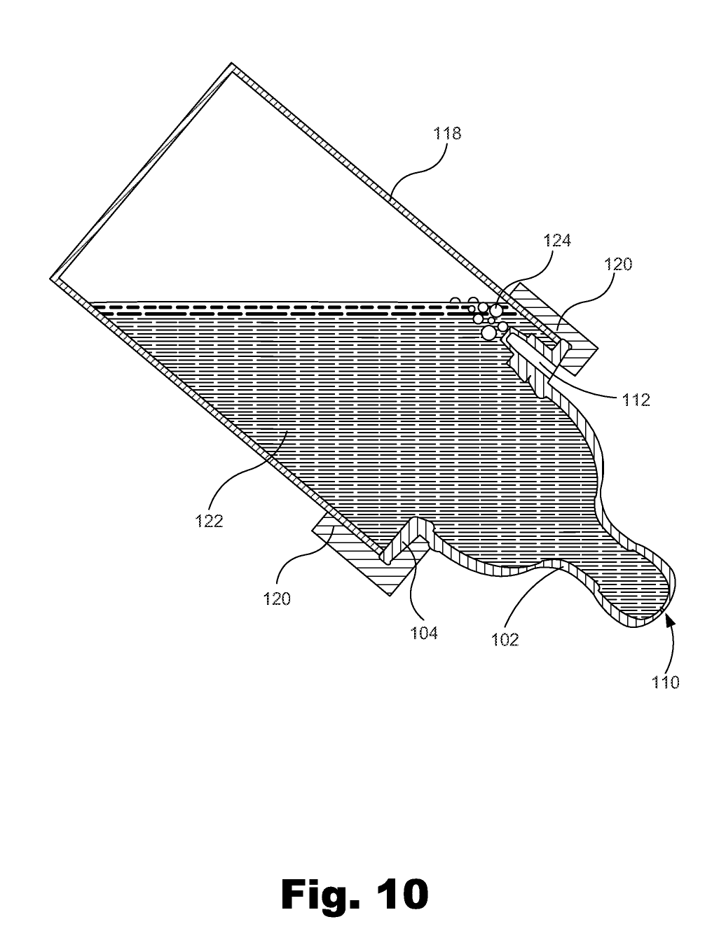

FIG. 3A further has a circle D defined thereon. Circle D defines a cross-sectional view of the teat (102) of the nipple (100) according to an embodiment of the present exemplary system and is shown in more detail in connection with FIG. 8. Finally, FIG. 3 has a circle C defined thereon. Circle C defines a cross-sectional view of the valve (106) and valve cavity (112) according to an embodiment of the present exemplary system and is show in more detail in connection with FIGS. 4 and 5.

Moving on, FIG. 3B is a cross-sectional view of the nipple of FIG. 2 along the line F-F according to an embodiment of the present exemplary system. Much like FIG. 3A, the nipple (100) in FIG. 3B is made of a resilient material such as silicon, latex or rubber. Additionally, the wall of the tip of the nipple (100) is configured to have a wall thickness greater than that of the middle portion of the nipple (100). Specifically, the nipple (100) tip and middle portion of the nipple (100) is configured to allow an infant to better grip the nipple in his or her mouth. Particularly the nipple (100), and more specifically the teat (102), has a profile and hardness which simulates a mother's breast. The features of the teat (102) will be discussed in more detail below in connection with FIGS. 8 and 9.

FIG. 3B, like 3A also shows the valve (106) defined within the mounting flange (104) according to an embodiment of the present invention. As discussed earlier, the placement of the valve (106) along the mounting flange (104) merely one embodiment, and it can be appreciated that the valve may be defined anywhere on the nipple (100). Additionally, in another embodiment, multiple valves (106) may be defined on the nipple (100). Preferably, each valve (106) and valve cavity (112) is defined along the mounting flange (104). This thereby prevents any discomfort or annoyance to a sucking child. The features of the valve (106) and valve cavity (112) will be discussed in more detail below in connection with FIGS. 4, 5, 6 and 7.

In one exemplary embodiment, the middle and tip portions of the teat (102) may include a number ribs (116) extending along and inside the nipple's (100) inner cavity (108). These ribs (116), may function as a means of support for the tip and middle of the teat (102). In one exemplary embodiment, the ribs (116) may run relatively vertical when the nipple (100) is viewed from the side as seen in FIGS. 3A and 3B. In another exemplary embodiment, the ribs (116) may run at an angle which is non-vertical and may spiral up towards the tip of the teat (102). In yet another exemplary embodiment, these ribs (116) may further be configured to imitate the internal ducts of a real female human breast.

It should be noted, however, that the wall thickness of the tip of the teat (102) is relatively thicker than the wall thickness of the middle section of the teat (102). Similarly, the wall thickness of the lower portion of the nipple (100) is relatively thicker than the wall thickness of the middle section of the teat (102). Again, the purpose of the varying wall thickness of the tip, middle and lower sections of the nipple (100) is to imitate, as best as possible, a real female human breast.

FIG. 3B further has a circle G defined thereon. Circle G defines a cross-sectional view of the teat (102) of the nipple (100) according to an embodiment of the present exemplary system and is shown in more detail in connection with FIG. 9.

Turning now to FIGS. 4 and 5, a cross-sectional view of the vent of the container nipple of FIG. 3 within circle C with a closed and open valve respectively is shown according to one embodiment of the present exemplary system. The valve cavity (112) has unique features which allow the exterior or ambient pressures to equalize easier with those pressures inside the container (FIG. 9, 118). Specifically, the valve cavity (112) has a minimum volumetric capacity of 0.9 cubic centimeters. This allows a conduit through which air may flow into the valve cavity (112) and eventually through the valve opening (114). Specifically, this helps to reduce the suction force required to increase the flow of liquid out of the container (FIG. 9, 118) when a child is sucking on the teat (102). In another exemplary embodiment, the valve cavity (112) may have a volumetric capacity of more than 0.9 cubic centimeters and the valve cavity (112) may extend the entire length of the container (FIG. 9, 118) or at least until the bottom of the container (FIG. 9, 118) in order to prevent the incoming bubbles from aerating the liquid in the container (FIG. 9, 118) and thereby increasing the amount of air taken in by the child while sucking on the teat (102).

Additionally, the valve cavity (112) has a substantially rectangular cross-section with a width of at least 2.0 millimeters and a length of at least 5.0 millimeters. This prevents the valve cavity (112) from caving in on itself due to changing pressures in the container (FIG. 9, 118). This design additionally adds to the ease of cleaning. Usually if the valve cavity (112) gets dirty, cleaning of a tubular valve cavity is hindered by the capillary forces involved. Indeed, the capillary forces do not allow water or other cleaning agents to flush out the containments and thereby may lead to health issues when the child subsequently drinks from the container (FIG. 9, 118). Instead, a substantially rectangular valve cavity (112) is more likely to break the capillary forces involved and thereby allow the valve cavity (112) to be cleaned easier.

Additionally, in one exemplary embodiment, the wall thickness of the substantially rectangular cross-section is at least 1.6 millimeters. This, again, is done to provide structural support to the valve (106) in order to prevent it from collapsing or pinching off due to the differing pressures inside the container (FIG. 9, 118) and the ambient atmosphere.

The valve cavity (112) also has a stepped triangular cross-section at the bottom of the cavity (112). The stepped triangular cross-section of the bottom of the valve cavity (112) helps to give structural stability to the valve (106), valve cavity (112), and valve opening (114). This, again, specifically prevents the valve cavity (112) from collapsing in on itself when the pressure changes in the container (FIG. 9, 118) or in the ambient atmosphere. Additionally, this configuration directs more of the pressure to one specific point, namely the bottom of the valve cavity (112) and in more particular the valve opening (114). This therefore allows more pressure to be placed against less area and thereby creates more force on the valve opening (114) in order to better equalize the pressure in the container (FIG. 9, 118) and the ambient atmosphere. In one exemplary embodiment, in order to give more stability and structure to the valve (106) the height of the stepped triangular cross-section is at least 3.0 millimeters. Additionally, the wall thickness of the stepped triangular cross-section if at least 0.8 millimeters in order to allow the negative pressure inside the container (FIG. 9, 118) to push on the least amount of material thereby allowing a consistent flow of air into the container (FIG. 9, 118) while still keeping the contents inside the container (FIG. 9, 118).

In order to prevent foreign contaminants from being trapped in the valve cavity (112), the valve cavity (112) also has an arcuate bottom surface. This will be discussed in more detail below in connection with FIG. 7.

Due to all of these features, the valve (106) requires no additional suction force to expel liquid from the nipple (100) when the container (FIG. 9, 118) is oriented in the inverted or feeding position as seen in FIG. 9. Specifically, ambient air is allowed to culminate within the valve cavity (112). This thereby provides the necessary air to equalize the pressure via the valve cavity (112).

Specifically looking a FIG. 5 now, a cross-sectional view of the vent of the container nipple of FIG. 3 within circle C with an open valve according to an embodiment of the present exemplary system is shown. As discussed earlier, the substantially rectangular cross-section of the valve cavity (112) with a width of a least 2.0 millimeters and a length of at least 5.0 millimeters, the stepped triangular cross-section of the valve cavity (112), as well as the arcuate bottom surface all help to contribute to the ease at which the liquid can be emptied out of the container (FIG. 9, 118) when a child sucks on the teat (102). Specifically, these features help open the valve opening (114) so as to allow air to flow into the container (FIG. 9, 118) as can be seen in FIG. 5.

Turning now to FIG. 6, a top view of the valve cavity of the container of FIG. 2 within circle E according to an embodiment of the present exemplary system is shown. The valve opening (114) is in the form of a semicircular slit at the bottom of the valve cavity (112). This allows the least amount of pressure to be placed on the valve opening (114) in order to displace it so as to allow ambient air to enter the container (FIG. 9, 118). In an alternative embodiment, the valve opening (114) may be a substantially complete circular slit thereby allowing easier air flow as well because of the limited amount of connected material between the valve opening (114) and the body of the valve cavity (112).

Additionally, the wall of the valve opening (114) has a minimum thickness of 0.8 millimeters. This adds support to the valve so that the liquid (FIG. 9, 122) in the container (FIG. 9, 118) will not flow out of the container (FIG. 9, 118) while still allowing ambient air to enter the container (FIG. 9, 118) to equalize the pressure.

In an alternative embodiment, the valve opening (114) may have a semicircular shape in which the valve opening (114) has a lip which prevents the valve opening (114) from opening into the valve cavity (112). This would prevent the valve opening (114) from leaking liquids into the valve cavity (112) and eventually out of the container (FIG. 9, 118).

FIG. 7. is a cross-sectional view of the nipple of FIG. 2 along line B-Baccording to an embodiment of the present exemplary system. As described earlier, the bottom of the valve cavity (112) has a substantially arcuate bottom surface. This arcuate bottom surface allows more pressure to be placed on less surface area. More specifically, the negative pressure created in the container (FIG. 9, 118) by gravitational force of the liquid leaving the container (FIG. 9, 118) is sufficient to overcome the material resistance of the valve opening (114) and allow ambient air to more easily flow into the container (FIG. 9, 118). Adding to this pressure is even more negative pressure created in the container (FIG. 9, 118) when a child sucks on the teat (102). However, little, if any, suction is required by the child to start the flow of liquid out of the container (FIG. 9, 118) and the child may rely solely on the negative pressure created by the gravitational force of the liquid in the container (FIG. 9, 118) to draw the liquid from the container (FIG. 9, 118). Therefore, the liquid (FIG. 9, 122) in the container (FIG. 9, 118) flows freely when the container (FIG. 9, 118) is in the inverted or feeding position and the discharge of the liquid (FIG. 9, 122) continues until the container (FIG. 9, 118) is emptied by the child.

Turning now to FIG. 8, a cross section view of the t of FIG. 3 within circle D according to an embodiment of the present exemplary system is shown. The teat (102) comprises a nipple duct (110) used as a way to express liquid out from the container (FIG. 9, 118). As discussed above the nipple (100) or more specifically the teat (102) may have more than one nipple duct (110) through which the liquid is expressed. This in turn will help mimic a real breast and thereby help an infant being weaned to accept the nipple (100).

Additionally, the teat (102) may also be formed in such as way as to better mimic a real nipple. Specifically, the wall of the upper portion of the teat (102) has a larger thickness than that of the middle portion of the teat (102). Further, lower section of the nipple (100) has a wall thickness which is relatively thicker than that of the middle portion of the teat (102). There, however, is no exterior cusp or edge formed on the outer surface of the teat (102) thereby creating a smooth surface for the child to suck on. Forming the teat (102) this way, however, gives an internal feel to the teat (102) which also mimics a real human female breast. Additionally, this allows the nursing child to grip the teat (102) more easily.

In one exemplary embodiment, the teat (102) has an hour glass type shape as seen in FIG. 8 with the top of the teat (102) having a diameter of at least 13 millimeters measuring from the exterior surface of the teat (102). Additionally, the midsection of the teat (102) has an exterior diameter of at least 10 millimeters. Therefore, the general shape of the teat (102) has an hour glass shape with the tip being relatively larger in diameter than the midsection. This therefore allows the child to latch onto the teat (102) easier.

In another exemplary embodiment, the teat (102) may be a spout nipple such that the shape of the teat (102) is oblong as viewed from the top. This thereby creates a more flattened teat (102) which may better accommodate different ages and types of children. The spout may not extend from the center of the nipple (100) and may instead be offset from center if viewed from the top.

In yet another exemplary embodiment, the teat (102) may be relatively longer in length so as to accommodate special needs children such as those who may have been born with a cleft lip or palate. Therefore, the length of the teat would extend relatively longer thereby allowing children with oral deformations to be able to suck on the nipple further back in the mouth.

In a further exemplary embodiment, the teat (102) may have a thumb shape with one relatively flat side and a second relatively rounded side. This shape may conform to the roof of the mouth of some infants in order to allow them to better suck from the container.

Finally, FIG. 9 is a cross-sectional view of a container with the nipple of FIG. 3 according to an embodiment of the present exemplary system. Apart from the other figures, FIG. 9 shows the addition of a container (118), a cap (120) attached to the container (118) and securing the nipple (100) there between, and a liquid (122) inside the container (118).

The container (118) is made of any material which would be able to hold and carry a liquid without letting it seep through it. Conventionally, these containers (118) have been made of plastic such as a polycarbonate or even glass. However, any material that is clear or near clear tends to be a better option due to the mother's ability to see the level of the contents inside the container (118).

In one exemplary embodiment, the container (118) additionally has threads (not shown) located at the top in order to receive mating threads (not shown) on the cap (120). The cap (120) is configured to fit tightly over the nipple (100) and thereby compress the nipple's (100) mounting flange (104) in between it and the container (118). Therefore, because the nipple (100) is made out of rubber or plastic, a tight seal is formed such that the liquid or other material to be consumed by the child will not flow out of nor will contaminants get into the container (118). In an alternative embodiment, the cap (120) may be fastened to the container (118) by a releasable clamp.

According to one exemplary embodiment, when the container (118) is inverted, the liquid (122) flows into the inner cavity (108) of the nipple (100) and a nursing child is able to express the liquid (122) out easily. The ease of expressing the liquid (122) out of the container (118) is due to the form and dimensions of the valve cavity (112) as discussed above. The negative pressure created by the gravitational pull exerted on the liquid (122) and expressed out of the nipple duct (110) is enough to open the valve opening (114) and allow exterior air to enter the container (118). If the liquid (122) level is high enough, air bubbles (124) will seep through the valve opening (114) and rise to the surface of the liquid (122). However, this will not affect the child because the bubbles will not form inside the inner cavity (108) of the nipple (100) but will instead follow the inner surface of the container (118) until it reaches the surface of the liquid (122). This is yet one more advantage of placing the valve (106) along the mounting flange (104).

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A nipple comprising:
a teat,
a mounting flange coupled to the teat defining a valve cavity therein, and
a valve positioned with in the valve cavity;
in which the valve is configured to equalize differing pressures.

2. The nipple of claim 1, in which the differing pressures are ambient air pressures, pressure within a container, liquid pressures, or combinations thereof.

3. The nipple of claim 1, in which the valve cavity has a volumetric area of at least 0.9 cubic centimeters.

4. The nipple of claim 1, in which the valve is a one-way valve.

5. The nipple of claim 1, in which the valve wall is semi-circular.

6. The nipple of claim 1, in which the nipple is coupled to a container.

7. The nipple of claim 1, in which the teat has one of an hour glass shape, a spout shape, an elongated shape, a thumb shape, or combinations thereof.

8. The nipple of claim 7, in which the tip of the teat has a diameter of at least 13 millimeters and the midsection of the teat has a diameter of at least 10 millimeters.

9. The nipple of claim 1, in which the valve has a stepped triangular base at the bottom of the valve.

10. The nipple of claim 1, in which the valve cavity has a rectangular cross-section with a width of at least 2.0 millimeters and a length of at least 5.0 millimeters.

11. The nipple of claim 1, in which the valve cavity has an arcuate bottom surface with a semi-circular slit through a wall having a substantially uniform thickness.

12. A system comprising:
a container; and
a nipple configured to be selectively and sealingly coupled to the container,
in which the nipple further comprises a valve and valve cavity configured to equalize the pressure differences between the ambient environment and interior of the container.

13. The nipple of claim 12, in which the teat has one of an hour glass shape, a spout shape, an elongated shape, a thumb shape, or combinations thereof.

14. The nipple of claim 13, in which the tip of the teat has a diameter of at least 13 millimeters and the midsection of the teat has a diameter of at least 10 millimeters.

15. The nipple of claim 12, in which the valve has a stepped triangular base at the bottom of the valve.

16. The nipple of claim 12, in which the valve cavity has a rectangular cross-section with a width of at least 2.0 millimeters and a length of at least 5.0 millimeters.

17. The nipple of claim 12, in which the valve cavity has an arcuate bottom surface with a slit through a wall having a substantially uniform thickness.

18. A method of making a container comprising:
providing a container; and
providing a nipple configured to be selectively sealed to an opening defined in the container,
in which the nipple further comprises a valve and valve cavity configured to equalize the pressure differences between the ambient environment and inside the container,
in which the valve cavity has a minimum volumetric capacity of 0.9 cubic centimeters, and
in which the valve cavity has a stepped triangular cross-section positioned at the bottom of the valve having a minimum wall thickness of 0.8 millimeters and a minimum height of 3.0 millimeters.

19. The nipple of claim 18, in which the valve cavity has a rectangular cross-section with a width of at least 2.0 millimeters and a length of at least 5.0 millimeters.

20. The nipple of claim 18, in which the valve cavity has an arcuate bottom surface with a semi-circular slit through a wall having a substantially uniform thickness.
